(19) United States
(12) Patent Application Publication
(10) Pub. No.: US 2009/0291037 A1
(43) Pub. Date: Nov. 26, 2009

(54) METHOD OF INERTISING THE IMPURITIES IN PHOSPHOGYPSUM

(75) Inventors: Shreesh Anant Khadilkar, Thane (IN); Manish Vasant Karandikar, Thane (IN); Padmanabhan Ramalingham Anikode, Thane (IN); Pradip Gopal Lele, Thane (IN); Rina Suresh Vaity, Thane (IN); Abhay Kant Pathak, Thane (IN)

Correspondence Address: BURNS & LEVINSON, LLP, 125 SUMMER STREET, BOSTON, MA, 02110, US

(73) Assignee: ACC LIMITED, Maharashtra (IN)

(21) Appl. No.: 12/438,593

(22) PCT Filed: Aug. 8, 2007
(86) PCT No.: PCT/IN07/00342

§ 371 Date: Feb. 24, 2009

(30) Foreign Application Priority Data
Aug. 25, 2006 (IN) 1342/MUM/2006

(51) Int. Cl. C01F 11/46; C22B 26/20

(52) U.S. Cl. 423/170; 423/555

(57) ABSTRACT

The invention pertains to a method of inertising free soluble impurities of phosphates and/or fluoride ions, in phosphogypsum, for use in commercial and industrial applications. The Phosphogypsum is pre-conditioned over an extended period of time separately or treated along with standard constituents by spraying, interblending or intergrinding during the process of manufacture, with alkyl, alkenyl and/or alkanol derivatives of ammonia, either individually or in combination with one another, to form stable intermediary phosphates and/or fluoride salts of the derivatives of ammonia.

### FIELD OF INVENTION

The invention relates to a method of inertising soluble impurities of phosphates and fluorides and/or fluoride ions, in phosphogypsum, to make it a suitable substitute for gypsum in commercial and industrial applications, by pre-treatment or in-process treatment of the phosphogypsum.

### BACKGROUND OF INVENTION

Gypsum, which is essentially CaSO₄.2H₂O, is an important and essential component of cement and constitutes 4-5% of cement. It is added to regulate the extreme setting reaction of cement, which occur in the presence of water. The scarce availability together with the cost of mineral gypsum, has made it necessary to seek and use the less expensive alternatives such as phosphogypsum. This is particularly important in the cement industry, where margins are low, cost of materials is very crucial. Phosphogypsum is a cheap byproduct from the phosphoric acid industry. It's cost is about half to one third of the cost of gypsum. Phosphogypsum is essentially CaSO₄.2H₂O. It is unsuitable for the manufacture of cement and several other commercial and industrial applications because of the presence of soluble impurities like Phosphates and Fluorides and other organic matter which may be present. These impurities when it exceeds minimal levels, severely restrict the use of phosphogypsum in commercial and industrial application especially in the manufacture of cement, since it retards the setting of cement when exposed to water, through the body of the cement. The soluble Phosphates reacts with calcium ions in the cement clinker and form insoluble calcium phosphate, which deposits on the surface of the hydrating grains of cement, thus hindering the penetration of water through the body of the cement grain and its reaction with water.

Similarly the Fluorides present in phosphogypsum precipitate as calcium fluoride in the lime rich region of the hydrating cement grains, preventing the setting of cement in the presence of water.

Several methods have been used to reduce the impurities in phosphogypsum and to make it equivalent to marine or mineral gypsum. The most popular process is by washing and leaching. Washing and leaching processes are cumbersome, since it involves handling of the slurry, and washing and drying the filtered cake. Another known method of treating phosphogypsum is with milk of lime [Ca(OH)₂], which converts the soluble impurities into insoluble calcium phosphate and calcium fluorides.

In patent Application number 1335/MUM/2003, the applicants have described a process of inertisation of the impurities in Phophogypsum by Thermochemical processing route, wherein a homogenous mixture of Phosphogypsum and reactive mineral elements capable of forming insoluble phosphates and volatile fluorides are prepared on a wet/dry basis, in the ratio of 1:100 to 50:100 by weight. The mixture is pyroprocessed in a furnace at a temperature of 150° C. to 800° C. for a period of 5-10 seconds to 50-60 mins., depending upon the type of pyro-processing technique used, to form processed phosphogypsum⁽¹⁾. The Reactive mineral elements such as, aluminum, Manganese, Magnesium, Silica, Strontium, iron and barium were used. Reactive minerals such as alum, Aluminium Sulphates, Gibbisite, α-allumina, High Alumina Cements, Alumino-silicate glasses, Bauxite, and alumina bearing clays were preferred. However, this is an energy intensive process.

Patent no; GB 1443747 describes a method of purification of phosphogypsum where in the phosphogypsum grains are washed with water under pressure and the free phosphoric acid and fluorine impurities are removed, thereby reducing the consumption of reagents. The Gypsum so obtained has less than 0.01%, 0.09% and 0.01% by weight of impurities of phosphorus, fluorine and carbon respectively. An alkylaryl sulphonate is used as wetting agent to facilitate separation of phosphogypsum grains from water. However this process which is a method of leaching requires large volumes water for washing, and levels of soluble fluorine and phosphate contaminants present in the gypsum crystal lattice remains unchanged This method is particularly unsuitable for the cement industry, since the soluble phosphates and fluorides present within, the crystal lattice of gypsum), interferes with the setting process of Cement.

The present invention describes the use of chemicals namely alkyl, alkenyl and alkanol substituted derivatives of ammonia, including those occurring as industrial waste, to inertise the impurities in phosphogypsum and to make it a suitable substitute of gypsum.

Technical grade Alkanol substituted derivatives of ammonia have been used in percentages ranging from 0.02% to 0.04% of 95-98% purity, along with Gypsum in cement manufacture, in order to reduce energy consumption while attaining desired grain size of cement grains. The addition of higher percentage weight of these substituted derivatives of ammonia is not cost effective, since the energy benefit obtained does not offset the high cost of technical grade compounds. The invention describes for the first time the use of alkyl, alkenyl and alkanol substituted derivatives of ammonia including those occurring as industrial wastes, to treat phosphogypsum to make it suitable substitute for gypsum in many industrial and commercial applications especially cement manufacture.

The use of treated phosphogypsum is of particular relevance in Cement Industry. Chemically treated Phosphogypsum, whether pretreated with the chemical additives or treated during the process of production with these chemical additives during the Cement manufacture by intergrinding/interblending process, the performance of phosphogypsum in multigrade cement, is made equivalent or even better than with use of mineral and marine especially in terms of setting characteristics and compressive strength developments of the Cements in cement sand Mortars and Concrete.

### SUMMARY

In its main aspect, the invention relates to a method of inertising free soluble impurities of phosphates and/or fluorides ions, in phosphogypsum, to make it a suitable substitute for natural gypsums in commercial and industrial applications. The phosphogypsum is pre-treated individually or treated along with standard constituents for the industrial applications, with alkyl, alkenyl and alkanol substituted ammonia derivatives, either individually or in combination with one another to form stable intermediary phosphates and/or fluoride salts of alkyl, alkenyl and/or alkanol substituted derivatives of ammonia.

In another aspect of this invention the alkyl, alkenyl and alkanol substituted derivatives of ammonia are added in the proportion of 0.08% to 5% by weight of phosphogypsum. The molar weight of the alkyl, alkenyl and/or alkanol substituted derivatives of ammonia are one among C₂H₇NO, C₄H₁₁NO₂, C₆H₁₅NO₃, C₂H₈N₂, C₄H₁₃N₃, C₆H₁₈N₄, C₈H₂₃N₅, C₆H₁₅NO, C₄H₁₁NO, C₅H₁₃NO₂, C₃H₉NO, C₉H₂₁NO₃.

In a more important aspect of the invention, industrial wastes containing the alkyl, alkenyl and alkanol substituted derivatives of ammonia is used.

In a further aspect of this invention, the industrial application for which treated phosphogypsum is to be used in manufacture of multigrade cement, which includes Ordinary Portland Cement, Portland Pozzolana Cement and Portland Slag Cement. The in—process treatment of phosphogypsum consists of addition of alkyl, alkenyl and alkanol substituted derivatives of ammonia while intergrinding/interblending phosphogypsum with standard constituents, during the Cement manufacture, to form the stable intermediary phosphates and fluoride salts of the alkyl, alkenyl and alkanol substituted derivatives of ammonia. The standard constituents, for cement manufacture are among the group of clinker minerals and supplementary cementitious materials like slag, fly ash, limestone, metakaolin etc.

In the final aspect of this invention, the cement manufactured using phophogypsum treated by the process revealed in this invention has compressive strengths of 15 to 75 MPa at hydration ages of 1 to 28 days. Simultaneously the cement so manufactured also has an initial setting time of 70 to 150 minutes and a final setting time of 150 to 250 minutes.

### DESCRIPTION

A brief description of the invention is as follows:

The following is a brief description of working of this invention.

In its main embodiment, the invention relates to a method of inertising the soluble impurities of phosphates and/or fluorides ions in phosphogypsum. Phospho-gypsum which is a byproduct of the phosphoric acid industry, can be used as an inexpensive raw material in place of marine or mineral gypsum, in industry, especially in cement manufacture. The phosphate and fluorides impurities are inertised either by the pretreatment of phosphogypsum with chemical additives namely alkyl, alkenyl and alkanol used singularly or by taking a mixture of these substituted derivatives of ammonia before it is used in industrial applications, including Cement Manufacture The afore referred chemical additives are sprayed over the phosphogypsum and allowed to condition over an extended period of time. In the alternative the phosphogypsum is inertised during the process of manufacture, in the interblending or intergrinding of cement and cementitious materials. The afore mentioned chemical additives may be used individually or in combination with one another. The substituted derivatives of ammonia react with the phosphate ions in phosphogypsum to form a stable ionic phosphate salt. Similarly they react with the fluoride impurities in phosphogypsum to form stable ionic fluorides salt. Thus the soluble impurities of phosphogypsum, which form undesirable phosphates and fluorides of calcium on the hydrating grains in the industrial application are inertised, and do not interfere in the setting process.

In another embodiment of this invention the alkyl, alkenyl and alkanol substituted derivatives of ammonia either individually or in combination are added in the proportion of 0.08% to 5% by weight of phosphogypsum. The proportion of the additive to be used would depend on the relative purity of the phosphogypsum and that of the chemical additive. When the additives used are in the form of industrial wastes, the proportion of the additives would depend on the concentration of these derivatives of ammonia in the wastes. The alkyl, alkenyl and/or alkanol substituted derivatives of ammonia used are all covered under the following molecular formula: C₂H₇NO, C₄H₁₁NO₂, C₆H₁₅NO₃, C₂H₈N₂, C₄H₁₃N₃, C₆H₁₈N₄, C₈H₂₃N₅, C₆H₁₅NO, C₄H₁₁NO, C₅H₁₃NO₂, C₃H₉NO, C₉H₂₁NO₃.

The alkyl, alkenyl and/or alkanol substituted derivatives of ammonia used may be among one or more substituted amines containing primary, secondary and tertiary amines and mixture there of and include Monoethanolamine (C₂H₇NO), Di-ethanolamine (C₄H₁₁NO₂), Tri-ethanolamine (C₆H₁₅NO₃) ethylenediamine (C₂H₈N₂), diethylene-tri amine (C₄H₁₃N₃), tri-ethylene terta-amine (C₆H₁₈N₄), tetra-ethylene penta-amine (C₈H₂₃N₅), N,N-diethyl-ethanolamine (C₆H₁₅NO), N,N-dimethylethanolamine (C₄H₁₁NO), N-methyl di-ethanolamine [C₅H₁₃NO₂], N-methylethanolamine [C₃H₉NO], tri-isopropyl amine (C₉H₂₁NO₃).

The formation of these stable salts is of particular relevance in the cement industry. Unlike the water soluble phosphates and fluorides, these stable ionic substituted ammonium phosphate salts and the substituted ammonium fluoride salts, do not interfere with the cement hydration reactions at early stages of cement setting.

The reaction of water soluble phosphates (i.e. free phosphoric acid) and fluorides (i.e. free hydrofluoric acid) in phosphogypsum and primary, secondary and tertiary alkyl, alkenyl and alkanol derivatives and their mixtures there of during hydration process is exemplified below by a typical example. The reaction produces an alkyl, alkenyl alkanol substituted ammonium salts of the acids viz: phosphoric acids and hydrofluoric acid.

R₃N+H₃PO₄→(R₃NH)⁺H₂PO₄⁻

Substituted Phosphoric acid alkyl, alkenyl/alkanol ammonium derivatives of Ammonia hydrogen phosphate salt

R₃N+HF→(R₃NH)⁺F⁻

Substituted Hydrofluoric acid alkyl, alkenyl/alkanol ammonium fluoride Derivatives of salt

### Ammonia

Wherein R is a Alkyl or Alkenyl or Alkanol or substituted derivatives of ammonia

These salts formed in the presence of water, further undergo reaction with calcium hydroxide released during the hydration process [2C₃S+6H→C₃S₂H₃+3Ca(OH)₂] and forms insoluble calcium phosphate and calcium fluoride which does not take part in the hydration reaction and in turn does not affect the setting time of cement as shown below. The alkyl, alkenyl and/or alkanol substituted ammonium salts form the corresponding hydroxide salt.

2(R₃NH)⁺H₂PO₄⁻+3Ca(OH)₂→Ca₃(PO₄)₂+2(R₃NH)⁺(OH)⁻+2H₂O

alkyl, alkenyl/alkanol Calcium hydroxide Calcium phosphate Hydroxide salt ammonium hydrogen→phosphate

2(R₃NH)⁺F⁻+Ca(OH)₂CaF₂+2(R₃NH)⁺(OH)⁻

alkyl, alkenyl/alkanol Calcium hydroxide Calcium fluoride Hydroxide salt ammonium fluoride

The characteristics of cement depend on the setting time and the relative compressive strength. Chemically pretreated or in-process treated phosphogypsum by the method disclosed herein, significantly enhances compressive strength and reduces initial and final setting time.

The following examples gives the comparative values of setting time as well as compressive strengths of OPC, PPC, PSC with chemically treated phosphogypsum. The Example 1, 2, 3 gives the comparative levels of soluble and insoluble phosphates and fluoride impurities in phosphogypsum and the chemically treated phosphogypsum of different sources with different levels of impurities with use of alkyl, alkenyl, alkanol substituted derivatives of ammonia. The phosphogypsum from different sources at different levels of the fluoride and phosphate impurities, designated as Phosphogypsum—A, B, C.

While the subsequent Examples 4, 5, 6 illustrates the comparative properties of the Cements viz: Ordinary Portland Cement (OPC), Portland Pozzolana Cement (PPC) and Portland Slag Cement (PSC) produced with & without the chemically treated Phophogypsum.

### Example-1

### Characteristics of Chemically Treated Phosphogypsum—A (with <0.8% Phosphate and Fluoride Impurities)

| | | Initial content | | | | After Treatment | | | |
|---|---|---|---|---|---|---|---|---|---|
| | | | | Water | | | | Water | |
| | % by | Total | | soluble | | Total | | soluble | |
| Raw material | weight | P₂O₅ | F | P₂O₅ | F | P₂O₅ | F | P₂O₅ | F |
| Phospho | 95-99.95% | 0.50 | 0.29 | 0.16 | 0.13 | 0.50 | 0.29 | 0.07 | 0.07 |
| Gypsum -A | | | | | | | | | |
| Alkyl, alkenyl, | 0.08-5.0% | | | | | | | | |
| alkanol | | | | | | | | | |
| substituted | | | | | | | | | |
| ammonia | | | | | | | | | |

### Example-2

### Characteristics of Chemically Treated Phosphogypsum—B (with 0.8-1.3% Phosphate and Fluoride Impurities)

| | | Initial content | | | | After Treatment | | | |
|---|---|---|---|---|---|---|---|---|---|
| | | | | Water | | | | Water | |
| | % by | Total | | soluble | | Total | | soluble | |
| Raw material | weight | P₂O₅ | F | P₂O₅ | F | P₂O₅ | F | P₂O₅ | F |
| Phospho | 95-99.95% | 0.81 | 0.24 | 0.24 | 0.13 | 0.81 | 0.24 | 0.08 | 0.08 |
| Gypsum -B | | | | | | | | | |
| Alkyl, alkenyl, | 0.08-5.0% | | | | | | | | |
| alkanol | | | | | | | | | |
| substituted | | | | | | | | | |
| ammonia | | | | | | | | | |

### Example-3

### Characteristics of Chemically Treated Phosphogypsum—C (with >1.3% Phosphate and Fluoride Impurities)

| | | Initial content | | | | After Treatment | | | |
|---|---|---|---|---|---|---|---|---|---|
| | | | | Water | | | | Water | |
| | % by | Total | | soluble | | Total | | soluble | |
| Raw material | weight | P₂O₅ | F | P₂O₅ | F | P₂O₅ | F | P₂O₅ | F |
| Phospho | 95-99.95% | 0.72 | 1.47 | 0.30 | 0.24 | 0.72 | 1.47 | 0.09 | 0.10 |
| Gypsum -C | | | | | | | | | |
| Alkyl, alkenyl, | 0.08-5.0% | | | | | | | | |
| alkanol | | | | | | | | | |
| substituted | | | | | | | | | |
| ammonia | | | | | | | | | |

### Example-4

### Improvement in Setting Time and Strength of OPC with Use of Chemically Treated Phosphogypsum

| | |
|---|---|
| OPC With | OPC With Chemically |
| Phosphogypsum | Treated Phosphogypsum |

Setting Time (Mins.)

| | | |
|---|---|---|
| Initial | 350 | 70-150 |
| Final | >420 | 160-240 |

Compressive Strength (MPa)

| | | |
|---|---|---|
| 1 Day | 15.5 | 17-20 |
| 3 Days | 48.7 | 50-53 |
| 7 Days | 59.0 | 58-61 |
| 28 days | 69.3 | 72-74 |

### Example-5

### Improvement in Setting Time and Strength of PPC with Use of Chemically Treated Phophogypsum

| | |
|---|---|
| PPC with | PPC with Chemically |
| Phosphogypsum | Treated Phosphogypsum |

Setting Time (Mins.)

| | | |
|---|---|---|
| Initial | 340 | 70-170 |
| Final | >420 | 140-250 |

Compressive Strength (MPa)

| | | |
|---|---|---|
| 1 Day | 11.8 | 12-15 |
| 3 Days | 40.1 | 40-42 |
| 7 Days | 51.4 | 51-53 |
| 28 days | 64.3 | 63-65 |

### Example-6

### Improvement in Setting Time and Strength of PSC with Use of Chemically Treated Phophogypsum

| | |
|---|---|
| PSC with | PSC with Chemically |
| Phosphogypsum | Treated Phosphogypsum |

Setting Time (Mins.)

| | | |
|---|---|---|
| Initial | 250 | 70-140 |
| Final | >340 | 180-250 |

Compressive Strength (MPa)

| | | |
|---|---|---|
| 1 Day | 7.7 | 7-9 |
| 3 Days | 25.6 | 23-26 |
| 7 Days | 40.9 | 39-42 |
| 28 days | 56.1 | 53-57 |

Soluble phosphates and fluoride impurities in the treated phosphogypsum are at the level of <0.10%, at which levels the impurities do not interfere in the hydration process. The treated phosphogypsum (Example-1, 2 & 3) is a lower cost substitute for gypsum in any industrial or commercial manufacture of OPC, PPC and PSC. It finds specific use in the cement industry, where normally gypsum is added to cement clinker to regulate the setting reaction of cement in the presence of water.

The Examples 7, 8, 9 exemplify the Cement quality produced in another embodiment of the invention where these alkyl, alkenyl alkanol substituted derivatives of ammonia were used in the inter ground/interblended OPC, PPC and PSC made with Phosphogypsum C.

| Example 7 | | | | Example 9 | |
|---|---|---|---|---|---|
| | OPC with | Example 8 | | | PSC with |
| OPC | PG-C + 0.08-5.0 | PPC | PPC with | PSC | PG-C + 0.08-5.0% |
| With | C₈H₂₃N₅ + | With | PG-C + 0.08-5.0 | with | C₃H₉NO + |
| PG-C | C₅H₁₃NO₂ | PG-C | C₄H₁₀NO₂+ | PG-C | C₉H₁₅NO₃ |

Setting Time (Minutes )

| | | | | | | |
|---|---|---|---|---|---|---|
| Initial | 340 | 70-150 | 340 | 70-150 | 340 | 70-150 |
| Final | >420 | 150-250 | >420 | 150-250 | >420 | 150-250 |

Compressive strengths (MPa)

| | | | | | | |
|---|---|---|---|---|---|---|
| 1 Day | 15.0 | 17-20 | 11.0 | 12-15 | 7.5 | 7-9 |
| 3 Days | 47.0 | 48-51 | 39.0 | 38-41 | 25.0 | 24-26 |
| 7 Days | 58.0 | 58-61 | 48.0 | 47-50 | 40.0 | 39-41 |
| 28 days | 67.0 | 68-70 | 60.0 | 59-61 | 55.0 | 54-56 |

The above examples illustrates the efficacy of the additive to substantially enhance the setting characteristics and compressive strengths of the different Cements manufactured with Phosphogypsum.

The setting of cement involves the reaction of clinker minerals with water to form a system of interlocking crystals, which lock the material together. The setting of cement is primarily due to the reaction of tri-calcium aluminate (Ca₃AlO₄), which is the most reactive of the clinker minerals present in cement.

The set regulating action of gypsum is primarily due to its reaction with tri-calcium aluminate. Calcium sulphate is soluble in water and aides in the setting process when it reacts with tri-calcium aluminate as given by the following reaction:

Ca₃AlO₄+CaSO₄+H₂O→CaO.Al₂O₃.3CaSO₄.32H₂O (Ettringite).

The stable intermediary ionic salts formed by the derivatives of ammonia temporarily locks the soluble fluoride and phosphate ions, so that the initial setting reaction is complete.

The ettringite is usually formed as a very fine grained crystal, which forms a coating on the surface of tricalcium aluminate particles. These crystals are too small to bridge the gaps between the particles of cement. The cement mix therefore remains plastic. After the initial hydration reaction of cement, a dormant period occurs during which the rate of hydration of cement is usually reduced. During this dormant period, ettringite crystals continue to grow and eventually are large enough to impede the mobility of cement particles. At this stage setting occurs. The ettringite crystal formation is not impeded by the insoluble phosphates and fluorides of calcium which are subsequently formed.

Thus treated phosphogypsum without the free impurities of phosphates and fluorides is made a cost effective equivalent to mineral or marine gypsum, for use in industrial application.

1. A method of inertising the free soluble impurities of phosphates and/or fluoride ions in phosphogypsum for use in industrial applications, by preconditioning of phosphogypsum over an extended period of time, or in process treatment of phosphogypsum together with one or more standard constituents used in the industrial application, by spraying, interblending or intergrinding with alkyl, alkenyl and/or alkanol derivatives of ammonia, either individually or in combination with one another, to form stable intermediary phosphate and/or fluoride salts of the derivatives of ammonia.

2. The method as claimed in claim 1, where in the alkyl, alkenyl and alkanol derivatives of ammonia are added in the proportion of 0.08% to 5% by weight of phosphogypsum.

3. The method as claimed in claim 2, where in the alkyl, alkenyl and/or alkanol derivatives of ammonia are among C₂H₇NO, C₄H₁₁NO₂, C₆H₁₅NO₃, C₂H₈N₂, C₄H₁₃N₃, C₆H₁₈N₄, C₈H₂₃N₅, C₆H₁₅NO, C₄H₁₁NO, C₅H₁₃NO₂, C₃H₉NO, C₉H₂₁NO₃.

4. The method as claimed in claim 3, where in industrial waste, containing alkyl, alkenyl and/or alkanol derivatives of ammonia is used.

5. The method as claimed in claim 3, where the industrial application for which phosphogypsum is to be used is manufacture of multigrade cement, including Ordinary Portland Cement, Portland Pozzolana Cement and Portland Slag Cement.

6. The method as claimed in claim 5, where in the standard constituents are among the group consisting of Cement, clinker and cementitious mineral constituents like fly ash, slag, Metakaolin, silica fume, calcined clays and volcanic ash.

7. The method as claimed in claim 6, where in the cement manufactured has compressive strengths of 15 to 75 MPa at hydration ages of 1 to 28-days.

8. The method as claimed in claim 7, where in the cement manufactured has an initial setting time of 70 to 150 minutes and a final setting time of 150 to 250 minutes.

9. Phosphogypsum treated by the method described in claim 1.

10. The method as claimed in claim 4, where the industrial application for which phosphogypsum is to be used is manufacture of multigrade cement, including Ordinary Portland Cement, Portland Pozzolana Cement and Portland Slag Cement.

11. Phosphogypsum treated by the method described in claim 2.

12. Phosphogypsum treated by the method described in claim 3.
